(19) United States
(12) Patent Application Publication
(10) Pub. No.: US 2018/0150606 A1
(43) Pub. Date: May 31, 2018

(54) AUTOMATIC MEDICAL CONDITION DETECTION AND NOTIFICATION SYSTEM

(71) Applicants: National Guard Health Affairs, Riyadh (SA); King Saud bin Abdulaziz University for Health Sciences, Riyadh (SA); King Abdullah International Medical Research Center, Riyadh (SA)

(72) Inventor: Yaseen ARABI, Riyadh (SA)

(73) Assignees: National Guard Health Affairs, Riyadh (SA); King Saud bin Abdulaziz University for Health Sciences, Riyadh (SA); King Abdullah International Medical Research Center, Riyadh (SA)

(21) Appl. No.: 15/364,980

(22) Filed: Nov. 30, 2016

(51) Int. Cl. G06F 19/00

(52) U.S. Cl. CPC G06F 19/345; G06F 19/322

(57) ABSTRACT

A system and method are provided for early recognition and escalating provider notification for an insidious medical condition. The method includes: setting, based on a patient clinical assignment, an escalating alert criteria including a set of diagnosis parameters and an alert timing; searching a patient record having a set of patient data for the escalating alert criteria; assigning a provider assignment based on the patient clinical assignment and the escalating alert criteria; creating an escalating alert procedure based on at least one of the patient clinical assignment, the provider assignment, the set of patient data, and the escalating alert criteria; sending a notification to at least one communication system in communication with a notification device based on the provider assignment; receiving a medical order in response to the notification; and modifying at least one of the set of diagnosis parameters and the alert timing based on the medical order.

### BACKGROUND

Severe sepsis and septic shock are responsible for significant morbidity and mortality. In the United States, sepsis mortality reportedly occurs in 65.5 per 100,000 persons. In Europe, the in-hospital mortality rate from sepsis is estimated to be 24.1%. Notably, the incidence of sepsis has dramatically increased in recent years, with the sepsis rate per 10,000 admissions doubling between 2000 and 2008. Moreover, in-hospital deaths are reported to be eight times greater for patients hospitalized for sepsis compared to those hospitalized with other diagnoses (17% and 2%, respectively). Sepsis-related mortality is also extremely costly to the healthcare system, with an estimated $14.6 billion in 2008 in USA. In Europe, 25% of sepsis patients are admitted to the intensive care unit (ICU) through the emergency department (ED). Compliance with evidence-based guidelines for severe sepsis and septic shock management has been shown to be low, which has been attributed to factors such as delayed recognition.

### SUMMARY

A method is provided for performing early recognition and escalating provider notification for an insidious medical condition, the method including: receiving, at a server, a patient clinical assignment from an electronic health records database; setting, based on the patient clinical assignment, an escalating alert criteria including a set of diagnosis parameters and an alert timing; searching, using processing circuitry, an patient record having a set of patient data within the electronic health records database for the escalating alert criteria; starting a timer when the search returns that the set of patient data match the set of diagnosis parameters; assigning a provider assignment based on the patient clinical assignment and the escalating alert criteria; creating an escalating alert procedure based on at least one of the patient clinical assignment, the provider assignment, the set of patient data, and the escalating alert criteria; adding the escalating alert procedure to a work list in the electronic health records database; sending a notification to at least one primary communication system configured to be in communication with at least one notification device based on the provider assignment; receiving, at the server, a medical order in response to the notification; and modifying at least one of the set of diagnosis parameters and the alert timing based on the medical order.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a flow diagram of an automatic medical condition detection and notification system including a hospital information system, an interfacing engine, a set of communication systems, where each communication system is configured to be in communication with one or more notification devices associated with one or more providers according to an example;

FIG. 1B show examples of the communication systems;

FIG. 1C shows examples of the providers;

FIG. 2A is a flow diagram of an alert escalation process according to an example;

FIG. 2B shows examples of sepsis criteria that can be used to trigger a sepsis alert escalation process;

FIG. 2C shows examples of escalating notification protocols that are configured to be implemented in performing the alert escalation process;

FIG. 2D shows examples of how patient data can be assigned weights for triggering the alert escalation process;

FIG. 3A is a screenshot of a work list of the hospital information system including a escalating alert configured to appear on at least one communication system according to an example;

FIG. 3B is a screenshot of the work list of FIG. 3A that is expanded to show a provider assignment in response to the escalating alert according to an example;

FIG. 4 is a screenshot of a provider order menu for inputting an medical order by the provider in response to the escalating alert according to an example;

FIG. 5 is a screenshot of a critical results notification table including a log of each escalating alert, provider assignment, notification, and event details according to an example;

FIG. 6A is a table showing a list of high-risk human failure modes in the process for treating sepsis according to an example;

FIG. 6B is a graph showing an overall compliance with a 4-element resuscitation bundle and mortality rate with initiation of an e-alert and of a sepsis response team according to an example;

FIG. 7 is a block diagram of an example computing system of a notification device; and

FIG. 8 is a block diagram of an example distributing computing environment including a cloud computing environment.

### DETAILED DESCRIPTION

A system and method are provided for performing early recognition and escalating provider notification for an insidious medical condition such as severe sepsis in a patient. The system is configured to determine when a set of patient data accessed from an electronic health record database match a set of escalating criteria associated with the insidious medical condition. When a match is determined, the system is configured to escalate, based on the set of escalating criteria, a notification to one or more notification devices associated with a provider assignment through one or more communication systems. The system is configured to escalate the notification based on not receiving an update in the electronic health record database. In some implementations, notification escalation is based on a hierarchical structure of a clinical staff and associated a communication method. The set of escalating criteria includes a notification silencing process that is done based on clinical parameters as well as alarm fatigue avoidance of the provider.

Referring now to the drawings, wherein like reference numerals designate identical or corresponding parts throughout the several views.

### Notification System

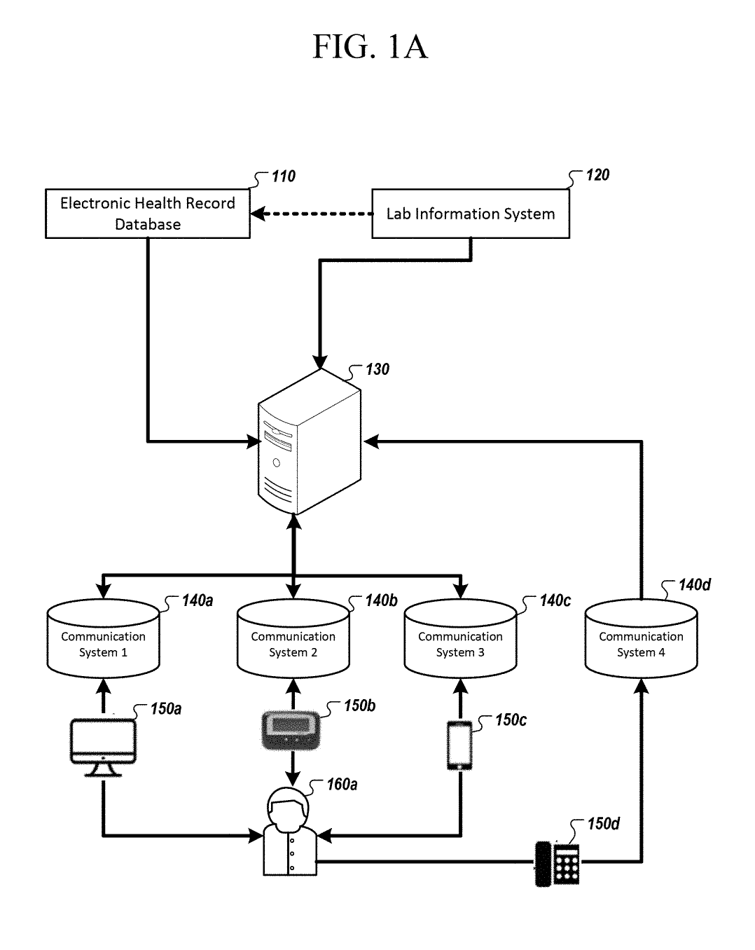

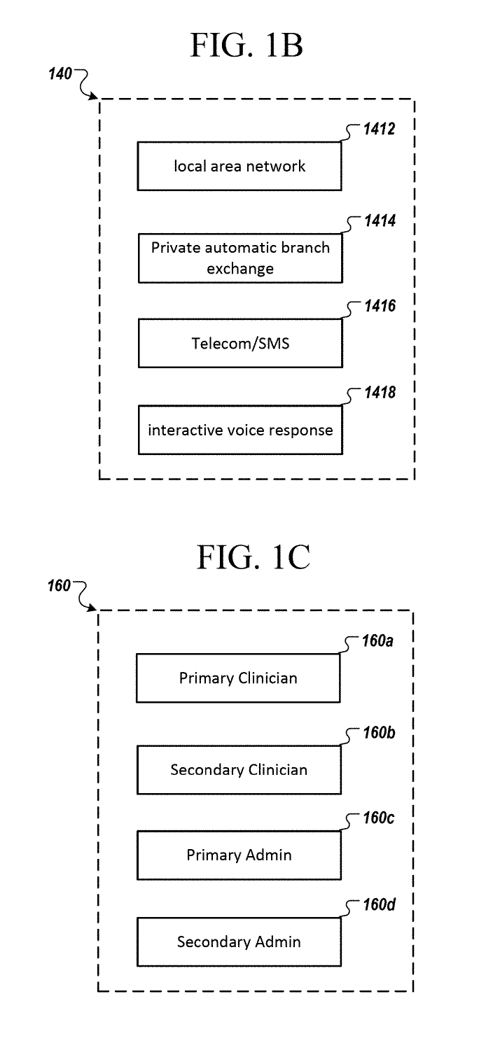

FIG. 1A is a flow diagram of an automatic medical condition detection and notification system including a hospital information system or electronic health record (EHR) database 110, a lab information system 120, a notification server 130, a set of communication systems 140a-d, where each communication system is configured to be in communication with one or more notification devices 150a-d associated with one or more providers 160a-d. In an example, the EHR 110 is configured to store a patient record having a set of patient data. In an example, the set of patient data can be manually entered the EHR 110 as well as automatically entered by the lab information system 120. In another example, the notification server 130 can be configured to receive the set of patient data from the lab information system 120 directly as well as by the ERR 110. In an example, the EHR 110 can be hosted on a single server or as part of a distributed system such as in cloud computing.

In some implementations, the notification server 130 can be configured to receive an escalating alert criteria including a set of diagnosis parameters and an alert timing. In an example, the alert timing includes a set of time thresholds based on the set of diagnosis parameters. In an example, the set of time thresholds can be based on an ordering of the set of diagnosis parameters that have been detected.

The notification server 130 can be configured to search the set of patient data for a match with the set of diagnosis parameters and start a timer when the search returns true. Next, the notification server 130 can be configured to perform an escalating alert procedure based on the patient clinical assignment, the provider assignment, the set of patient data, and the escalating alert criteria. The escalating alert procedure includes sending a notification to at least one primary communication system configured to be in communication with at least one notification device based on the provider assignment.

An example of the ERR 110 system is the QuadraMed® Computerized Patient Record System (QuadraMed Affinity Corp., Reston, Va., USA). An example of the lab information system 120 is available by a Cerner™ (Kansas City, Mo.). In an example, the notification server 130 can include an interface engine such as the Rhapsody application by Orion Health (Scottsdale, Ariz.).

Examples of the communication system can include a local area network (LAN) 1412, a private automatic branch exchange (PABX) 1414, a telecom/SMS 1416, and an interactive voice response (IVR) 1418. In an aspect, different communications systems can be used for backup as well as to avoid alarm fatigue from overuse of a single communication system. In an example, each communication system can have an associated notification device.

Examples of the providers can include clinicians such as a doctor, a nurse, and a physician assistant, as well as staff and administration members such as a Section Head, Department Chairman, quality improvement personnel, clinical staff coordinator, etc. In an example, each provider can be assigned as a primary clinician 160a, a secondary clinician 160b, a primary admin 160c, and a secondary admin 160d (See FIG. 1C). In an example, at least one provider is an intensive care registered physician/nurse who is trained on sepsis management using didactic lectures and simulation-based learning.

Examples of the communication systems include a computer 150a, a pager 150b, a mobile device 150c, and a telephone or intercom 150d (See FIG. 1B). In an example, some communication systems are used for one way notification and communication to notification devices such as the pager 150b and the intercom 150d. These types of notification devices may rely on another notification device and/or communication system for provider input.

In an example, the notification can include detailed information such as a patient identity, lab results with predetermined (i.e. normal) ranges, a patient location, and a provider referral contact information through phone, e-mail, SMS, and LAN. In another example, the notification can include summarized information such as a patient medical record number (i.e. EHR ID), and a phone number to acknowledge the notification and/or to provide a medical order.

### Alert Escalation Process

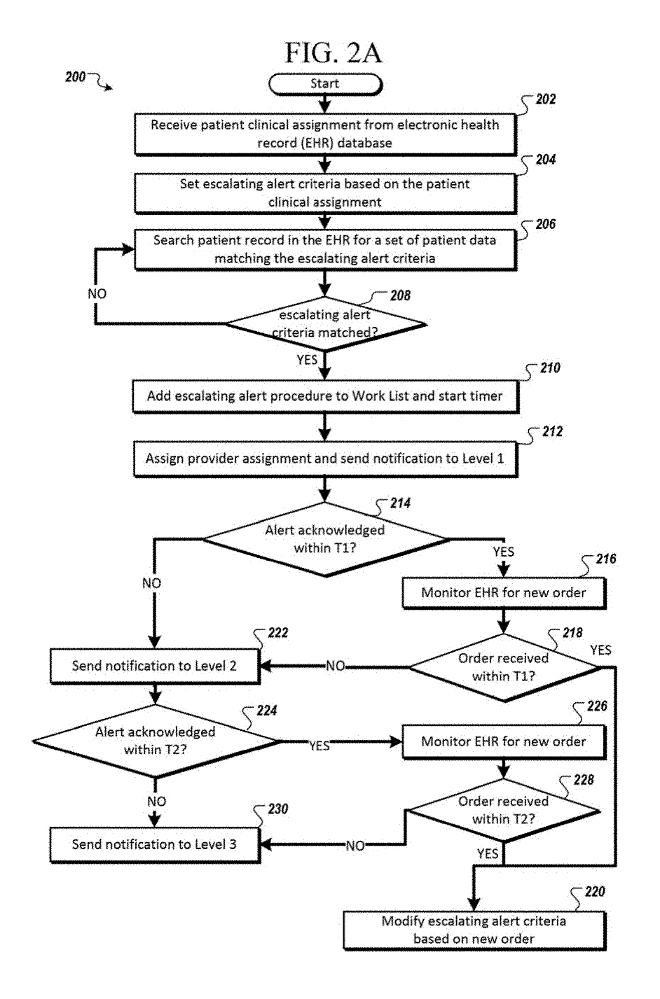

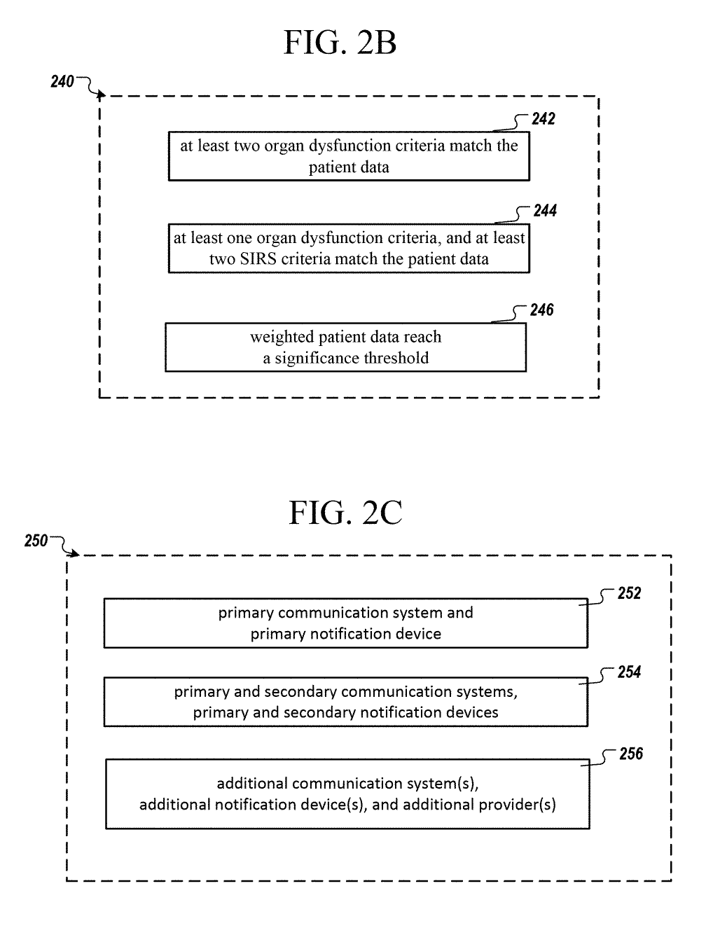

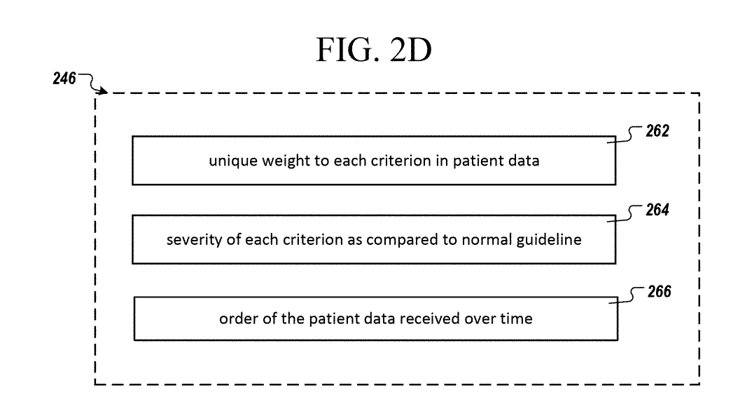

FIG. 2A is a flow diagram of an alert escalation process 200 according to an example.

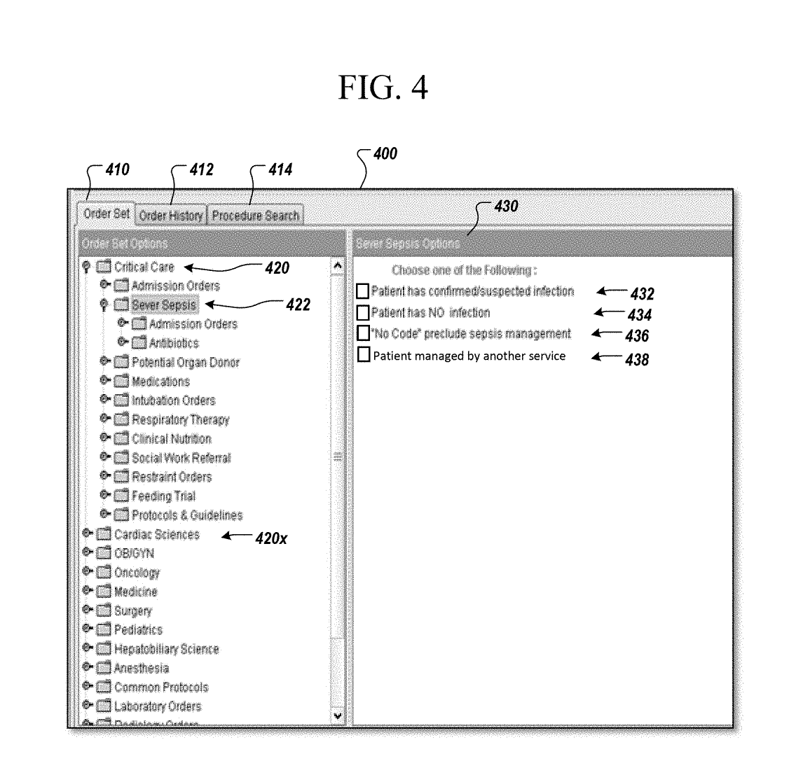

At step 202, receive patient clinical assignment from the EHR 110. Examples of the patient clinical assignment include if the patient is in a particular hospital service 420x (e.g., Critical Care, Cardiac Sciences, OB/GYN, Oncology, etc.) as shown in FIG. 4.

At step 204, the notification server 130 sets an escalating alert criteria 240 based on the patient clinical assignment. In some implementations, the escalating alert criteria 240 can differ for each hospital service and patient demographic (e.g., adult, pediatric, geriatric, etc.). In an example, the escalating alert criteria 240 can be tailored for the Critical Care service. In an aspect, the escalating alert criteria 240 tailored for the Critical Care service can have different alert timing as compared to another hospital service which may assign different significance to the patient data based on a specific organ. For example, the alert timing for the Critical Care service can have a modified set of time thresholds based on a set of diagnosis parameters reflecting a physiological system of the patient. In an example, the modified set of time thresholds can be based on an ordering of the set of diagnosis parameters that have been detected. In the Cardiac Sciences, the alert timing can be based on a specific organ, such as the heart (e.g., EKG, heart rate).

In an example, the escalating alert criteria 240 can be determined automatically by the notifications server 130 using diagnosis trend data for different patient demographics, patient assignments, etc. In an example, when another patient record, associated with another patient, has similar patient data and an associated escalating alert criteria 240, the notification server 130 can be configured to suggest the associated escalating alert criteria 240.

In an aspect, the escalating alert criteria 240 can be modified to prevent alert fatigue. In an example, the notification server 130 can be configured to detect alert fatigue based on patterns of how the clinician responds and to modify the alert timing based on the patterns. In an example, alert fatigue occurs when a clinician changes their behavior to an alert or notification over time. For instance, at a beginning of a shift a clinician may respond with an urgent timing as compared to at an end of the shift. In some cases, the clinician may ignore the notification or wait for a reminder before responding. Based on the detection of the clinician's response, the notification server 130 can be configured to modify at least one of the communication system 140a-d, the notification device 150a-d, and the alert timing.

In an example, the set of escalating criteria includes a set of Systemic Inflammatory Response Syndrome (SIRS) criteria and a set of indications of organ dysfunction criteria. In an example, the SIRS criteria includes temperature >38° C. OR <36° C.; heart rate >90 beats/min; respiratory rate >20 breaths/min; white blood cell count >12,000/mm³ OR <4,000/mm³.

In an aspect, the escalating criteria may evolve based on different criteria as determined by recommendations from medical conferences and clinical practice. In an example, the notification server 130 can be configured to automatically update the escalating criteria by accessing a remote database storing the recommendations. Alternatively, the different criterion can be manually entered by the provider.

In an example, the set of indications of organ dysfunction includes systolic blood pressure 86 to 90 mmHg with intravenous fluids or <86 mm Hg regardless of fluids; blood oxygen saturation of 85 to 90% with supplemental oxygen or <85% without oxygen; lactate >2 mmol/L.

At step 206, search a patient record in the EHR 110 corresponding to the patient for a set of patient data matching the escalating alert criteria 240. In an example, the search is continuously being done by the notification server 130.

At step 208, a determination is made if the escalating alert criteria 240 correspond to the set of patient data associated with the patient record. When the escalating alert criteria 240 match the patient record associated with the patient, the process 200 advances to step 210. Otherwise, the process 200 returns to step 206. Optionally, when at least one missing and/or outdated patient data from the set of patient data based on the escalating alert criteria is identified, at least one medical order based on the identified missing and/or outdated patient data can be automatically generated.

In an example, the escalating alert criteria 240 is considered to correspond to the patient record associated with the patient when at least two organ dysfunction criteria match the set of patient data (242 in FIG. 2B). In an example, the escalating alert criteria 240 are matched when at least one organ dysfunction criteria and at least two SIRS criteria correspond to the set of patient data (244 in FIG. 2B). In an embodiment, the escalating alert criteria 240 are considered matched when the patient data are weighted and reach a significance threshold (246 in FIG. 2B). In some implementations, the patient data can be assigned weights by the notification server 130 in several ways (See FIG. 2D). In an example, a portion of the patient data can have a unique assigned weight that is accumulated into a total weight reaching the significance threshold (262). In an aspect, the assigned weight for each criterion/symptom and measurand can be modified as determined by guidelines and recommendations from medical conferences and clinical practice. In an example, the notification server 130 can be configured to perform web crawling of websites that include the recommendations from medical conferences in real-time as well as to store the guidelines and recommendations in a local memory or remote database. In an example, the EHR 110 can be configured to store the guidelines and recommendations.

In another example, the patient data can be assigned weights based on a severity of each criterion as compared to a predetermined (i.e. normal) guideline for a respective patient data (264). For instance, a criterion of the patient data can be within a predetermined guideline range, within a first deviation from the predetermined guideline range, or a second deviation from the predetermined guideline range, each range having a respective assigned weight. In an example, the predetermined guideline range for a patient blood oxygen saturation level can be greater than 90%. The first deviation for the blood oxygen saturation level can be less than 90% with the patient receiving supplemental oxygen, and the second deviation for the blood oxygen saturation level can be less than 85% with the patient not receiving supplemental oxygen.

In another example, the patient data can be assigned weights based on an ordering of the patient data received over time (266). For instance, the insidious medical condition can be diagnosed by a pattern or trend in two or more criteria matching a diagnosis parameter. When the patient record reflects that the patient data has a new or updated criterion matching the pattern or trend, the assigned weight to the patient data can be modified (i.e. increased). When the total weight passes the significance threshold, the escalating alert criteria 240 is considered matched.

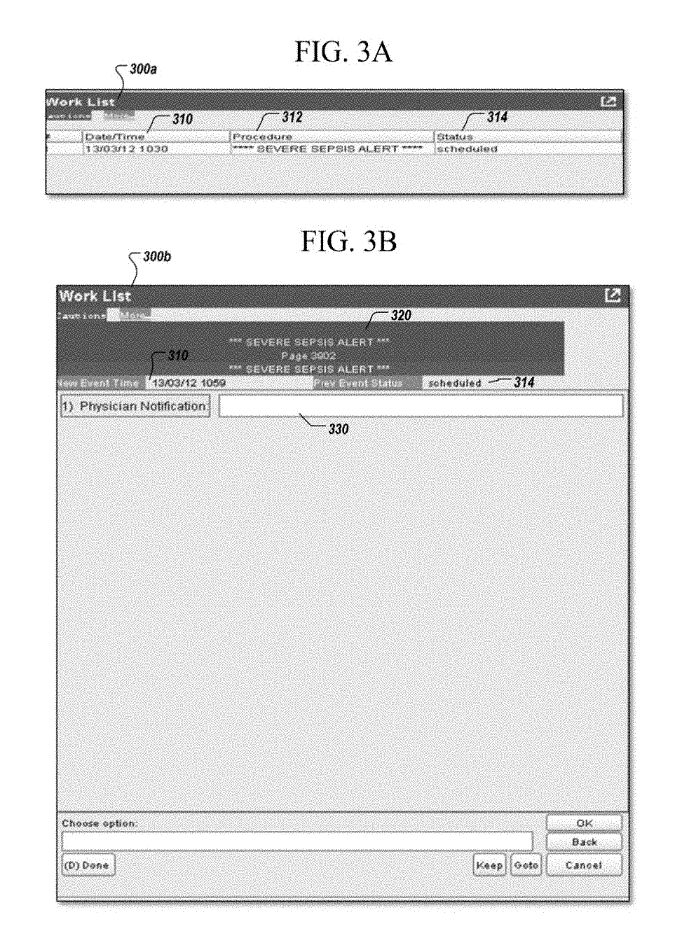

At step 210, a procedure 312 is added to a work list 300a-b (See FIG. 3A) and a timer is started. In some implementations, the timer can be within the EHR 110, the lab information system 120, and the notification server 130. In an example, a status of the timer can be duplicated in any of the communication systems and notification devices. In an aspect, the timer is configured to monitor a timeframe to ensure compliance with the escalating alert criteria 240 which includes a requirement of administering antibiotics within the timeframe. In an example, the timeframe is an hour from the patient data matching the set of escalating criteria associated with the insidious medical condition.

In an example, the timeframe is modified to account for a delay in receiving a provider response to a request for additional patient data. For example, since it is important to administer antibiotics within an hour of a patient having sepsis, a delay in receiving the patient data and/or the lab results resulting from the medical order can be tracked and be used to modify the escalating alert criteria 240. For example, a prolonged delay in receiving a provider response to the notification can be tracked and used to modify the escalating alert criteria 240 to shorten the alarm timing.

FIG. 2C shows examples of escalating notification protocols 250 that are configured to be implemented in performing the escalating alert escalation process. In an aspect, the staff and administration members have a hierarchical structure which the escalating alert escalation process is configured to use for assignment of the providers to the notification devices.

Referring back to FIG. 2A, at step 212, a provider assignment 330 is assigned and a notification is sent to a Level 1 protocol 252. In an example, the provider assignment 330 is automatically assigned by the notification server 130 based on historical data. For example, the notification server 130 can be configured to track a number of patients the clinician is already providing care for in order to determine their availability and to assign the provider assignment 330 based on the availability. In another example, the notification server 130 can be configured to determine how successful the clinician is at treating sepsis patients based on other patient records with similar patient data and to assign the provider assignment 330 based on the success rate.

Alternatively, in an example, the Level 1 protocol 252 includes sending the notification to a primary communication system in communication with a primary notification device corresponding with the provider assignment 330. In an example, the primary communication system can be any one of the set of communication systems 140a-d. In an example, the primary notification device can be any one of the notification devices 150a-d associated with one or more providers 160a-d. In an example, the provider assignment 330 can include a primary provider and a secondary provider. In an aspect, the primary provider can be set as any one of a primary clinician 160a, a secondary clinician 160b, a primary admin 160c, and a secondary admin 160d. In an aspect, the secondary provider can be set as any one of the primary clinician 160a, the secondary clinician 160b, the primary admin 160c, and the secondary admin 160d that is different than the primary provider.

In an example, the procedure 312 can have an assigned date and time 310 and a status 314. In an example, the status 314 can be automatically updated based on the weighted patient data 246 as well as other conditions of the patient, etc. FIG. 3B shows an expanded view of the work list 300b having a prompt to input the provider assignment 330.

Referring back to FIG. 2A, at step 214, a check is done to determine if an acknowledgement has been received within a timer threshold T1 based on the alert timing (e.g. 10 min). When the acknowledgement has been received within the timer threshold T1 (YES), the process 200 advances to step 216 and the EHR 110 is automatically searched by the notification server 130 for a new medical order indicating that an action has been taken based on the notification. In an example, the new medical order can be a procedure added to the work list for administering an antibiotic.

In an example, the automatic medical condition detection and notification system can be configured to generate a medical order as a recommendation and the provider can acknowledge the notification by selecting the medical order that is generated by the automatic medical condition detection and notification system. In an example, the notification server 130 can be configured to access stored medical orders from the EHR 110 or another database used for storing the guidelines and recommendations associated with treating the insidious medical condition.

FIG. 4 shows a screenshot of a provider order menu 400 for inputting a medical order by the provider in response to an escalating alert for sepsis according to an example. In an example, a set of severe sepsis options 430 include: patient has suspected/confirmed sepsis (432), patient has no infection (434), code status preclude sepsis management (436), and that the patient has sepsis and is being managed by another hospital service (438).

The option of patient has suspected/confirmed sepsis (432) can be considered a “sepsis inactivation transit” procedure which can be ordered from a critical care or ICU order set 420. The option 432 is configured to remain active for 48 hours and automatically expire. While, the option 432 is active, the escalating alert will be inactivated. In an aspect, the escalating alert will be inactivated to prevent alarm fatigue. After 48 hours, the escalating alert will be active again.

The option of patient has no infection (434) can be considered a “sepsis inactivation transit” procedure which can be ordered from a critical care or TCU order set 420. The option 434 is configured to remain active for 24 hours and automatically expire. While, the option 434 is active, the escalating alert will be inactivated. After 24 hours, the escalating alert will be active again.

The option of code status preclude sepsis management (436) can be considered a “sepsis inactivation permanent” procedure which can be ordered from the critical care or ICU order set 420. The option 436 is configured to enter into the work list 300a-b for acknowledgment by the provider. After acknowledgment by the provider, the escalating alert will be inactivated permanently.

The option that the patient has sepsis and is being managed by another hospital service (438) can be considered a “sepsis inactivation transit” which can be ordered from the critical care or ICU order set 420. The option 438 is configured to remain active for 4 hours and automatically expire. As long as this procedure is active the escalating alert will be inactivated.

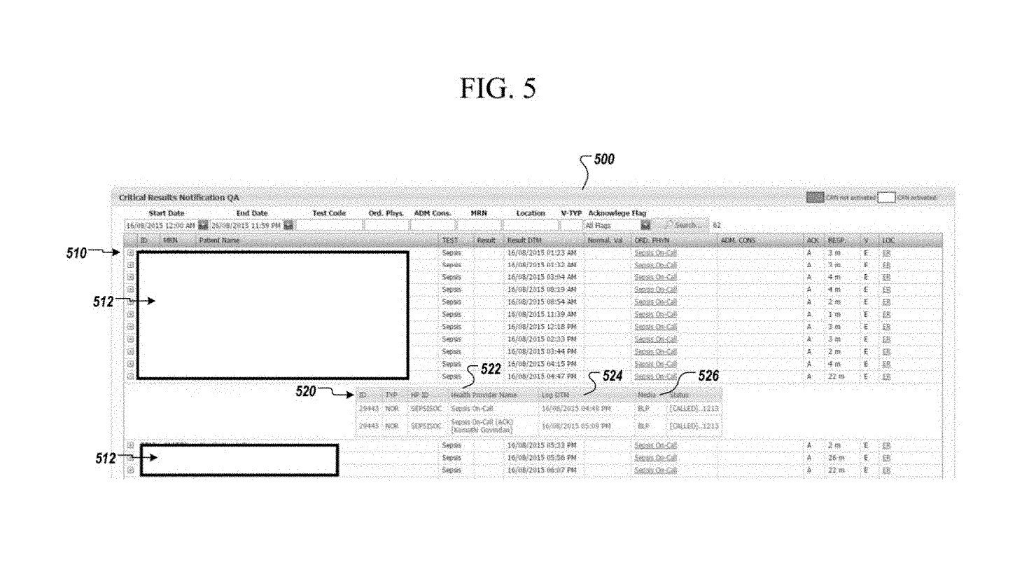

As shown in FIG. 5, each work list can be managed and monitored in a critical results notification table 500 including a log 510 of each escalating alert, patient information 512, and an expanded view of event details including a provider assignment 522, a notification timing 524, an notification device contacted 526 as well as other event details according to an example. In an example, the notification timing 524 can track the timers using the timestamps of each event.

Referring back to FIG. 2A, at step 218, a check is done to determine if an order has been received within the timer threshold T1. When an order has been received within the timer threshold T1 (YES), the process advances to step 220.

At step 220, the escalating alert criteria 240 is configured to be set based on the new medical order. In an example, the new medical order can introduce a delay in the alert timing.

Returning to the step 214, when the acknowledgement has not been received within the timer threshold T1 (NO), the process 200 advances to step 222.

At step 222, a notification is sent to a Level 2 protocol 254. In an example, the Level 2 protocol 254 includes sending the notification to the primary and the secondary communication system in communication with the primary notification device and the secondary notification device corresponding with the provider assignment 330. In an example, the secondary communication system can be any one of the set of communication systems 140a-d. In an example, the secondary notification device can be any one of the notification devices 150a-d associated with one or more providers 160a-d. In an aspect, the secondary communication system is different than the primary communication system. In an aspect, the secondary notification device is different than the primary notification device.

In an example, the Level 2 protocol 254 includes checking to ensure that the provider assignment 330 for the secondary notification device is different than the primary provider.

At step 224, a check is done to determine if an acknowledgement such as the new medical order has been received within a timer threshold T2 based on the alert timing (e.g. 20 min). When the acknowledgement has been received within the timer threshold T2 (YES), the process 200 advances to step 226 and the EHR is monitored for a new order.

Step 226 is followed by step 228 where a check is done to determine if an order has been received within the timer threshold T2. When an order has been received within the timer threshold T2 (YES), the process 200 advances to step 220. When an order has been not received within the timer threshold T2 (NO), the process 200 advances to step 230.

Returning to step 224, when the acknowledgement has not been received within the timer threshold T2 (NO), the process 200 advances to step 230.

At step 230, a notification is sent to a Level 3 protocol 246. In an example, the Level 3 protocol 246 includes sending the notification to additional communication system(s), additional notification device(s), and additional provider(s) corresponding with the provider assignment 330. In an aspect, the additional communication system is different than the primary and secondary communication system. In an aspect, the additional notification device is different than the primary and secondary notification device. In an aspect, the notification device is different than the primary and secondary notification devices. In an example, the Level 3 protocol 256 includes checking to ensure that the provider assignment 330 for the secondary notification device is different than the primary provider.

### Advantageous Features

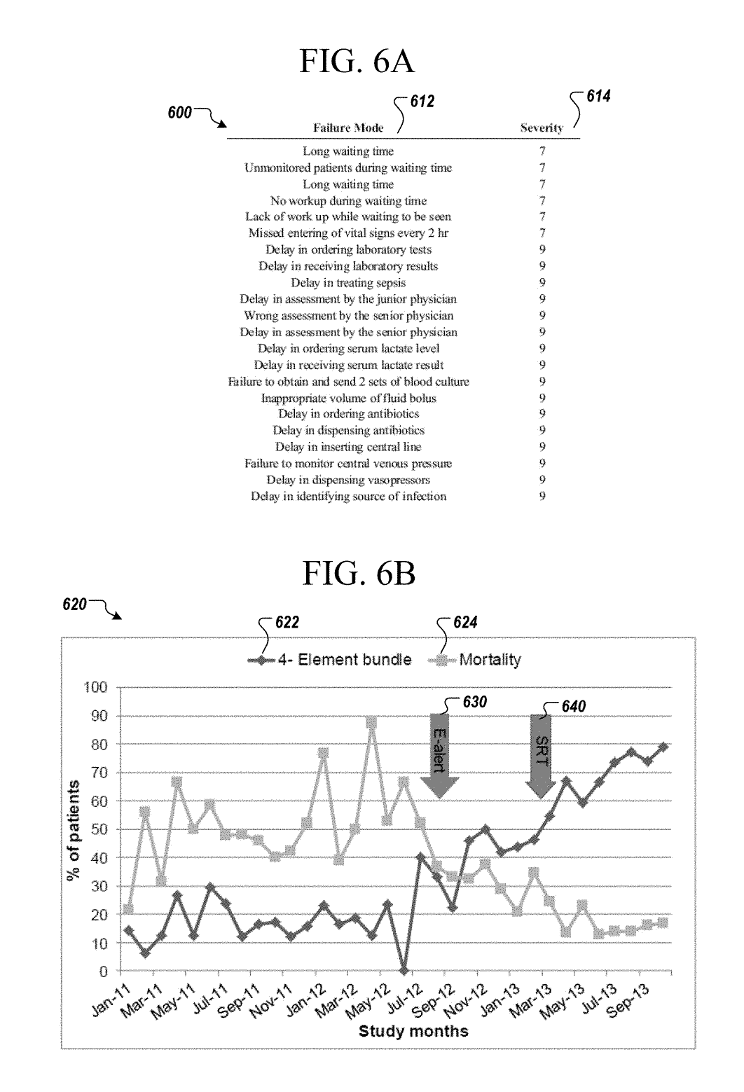

FIG. 6A is a table 600 showing a list of high-risk human failure modes 612 and an assigned severity 614 in the process for treating sepsis according to an example. The examples of high-risk human failure modes 612 and the assigned severity 614 in the process for treating sepsis are described in a publication by Alamry A, Owais SM, Marini AM, Al-Dorzi H, Alsolamy S, and Arabi Y titled “Application of Failure Mode Effect Analysis to Improve the Care of Septic Patients Admitted Through the Emergency Department,” published in the Journal of Patient Safety (2014), herein incorporated by reference in its entirety.

FIG. 6B is a graph 620 showing an overall compliance with a 4-element resuscitation bundle 622 and mortality rate 624 with initiation of an e-alert 630 implementing the alert escalation process 200 on the notification server 130 and of a Sepsis Response Team (SRT) 640 interacting with the e-alert 630 using one or more notification devices 150a-d according to an example in a study. The study was conducted in a 900-bed tertiary-care academic hospital. The emergency department receives >200,000 patients per year, is staffed by board-certified emergency medicine physicians and has 15 resuscitation beds for high-acuity patients and 49 beds for moderate-acuity patients. The Intensive (critical) Care Department staffs 5 ICUs on a 24-hour/7-day in-house basis, has a rapid response team and provides coverage for boarding patients in the emergency department who meet ICU admission criteria.

The study included a pre-post two-phased implementation that included a pre-intervention phase (Jan. 1, 2011 to Sep. 24, 2012), e-alert phase (Sep. 25, 2012 to Mar. 3, 2013) and SRT phase (Mar. 4, 2013 to Oct. 30, 2013). The e-alert phase included implementing the alert escalation process 200. The SRT phase included ensuring that the primary clinician was an intensive care registrar physician and a nurse who were trained on sepsis management using didactic lectures and simulation-based learning. The 4-element resuscitation bundle includes (1) serum lactate obtained within 6 hours of presentation, (2) blood cultures taken before administration of broad-spectrum antibiotics, (3) broad-spectrum antibiotics administered within 3 hours of admission to the emergency department, (4) 20 mL/kg of crystalloid (or equivalent) administered in patients who were hypotensive or had lactate >4 mmol/L.

The study demonstrates that the SRT 640 interacting with the e-alert 630 implementing the alert escalation process 200 was associated with reduction in crude mortality and improvement in the care process of sepsis management; a significant improvement in the timeliness of lactate measurement, obtaining of blood cultures, antibiotic administration and achievement of central Venus pressure (CVP) and central venous oxygen saturation (ScvO2) targets and reduction in mortality and length of stay. Combining the e-alert 630 with the SRT 640 exemplifies a technical solution to the problem of performing early recognition of an insidious medical condition and escalating provider notification based on an appropriate specialty for the insidious medical condition when timing is critical to the patient treatment. An escalating alert that is activated as soon as abnormal values are entered has the advantage of acting as a decision support system that bypasses many human-related shortcomings; thus has the advantage of high reliability and sustainability compared to paper-based screening tools.

As shown in FIG. 6B, the disclosed system and method for performing early recognition and escalating provider notification has shown to be effective in overcoming the high-risk human failure modes 612 in treating patients with sepsis. Therefore, the disclosed computerized system provides improvements to early recognition and notification of medical conditions that are not possible to be achieved through manual recognition and notification implementations without the processes described herein. Further, since the success in diagnosing and treating a patient with an insidious medical condition is dependent on conditional timing as well as the historical behavior of the clinician, the disclosed system and method's integration of these factors have a proven more effective than existing options.

### Hardware Description

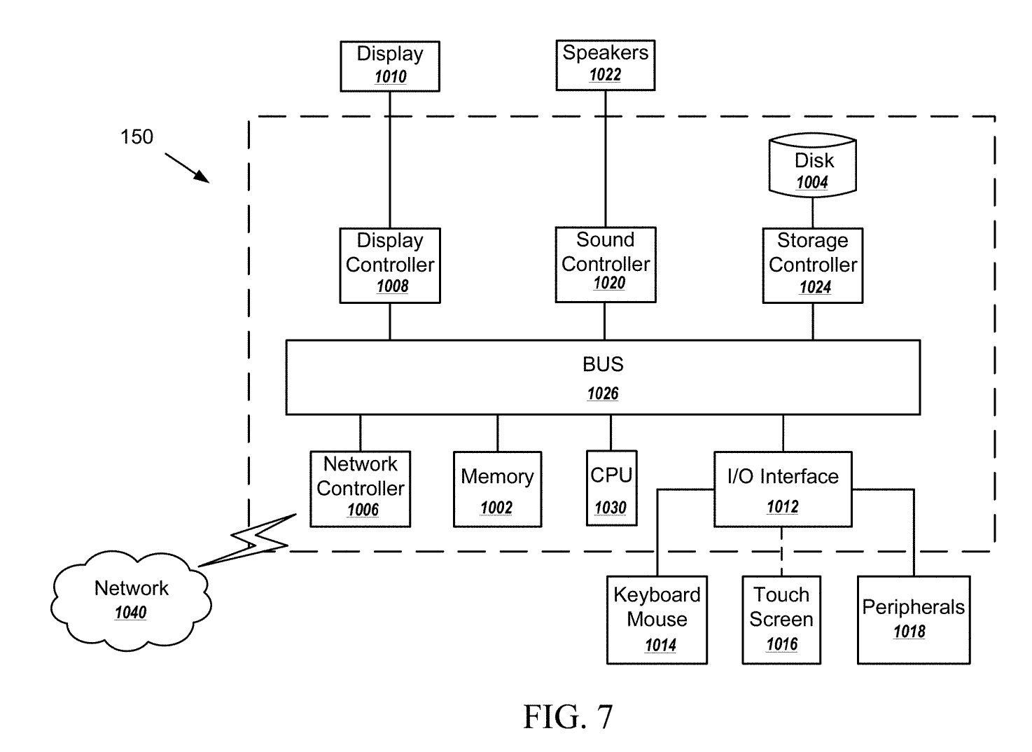

Next, a hardware description of a notification device or computing device 150, mobile computing device, or server according to exemplary embodiments is described with reference to FIG. 7. In FIG. 7, the computing device, mobile computing device, or server includes a CPU 1030 which performs the processes described above. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device, mobile computing device, or server communicates, such as a server or computer.

Further, a portion of the claimed advancements may be provided as a utility application, background daemon, or component of an operating system, or combination thereof, executing in conjunction with CPU 1030 and an operating system such as Microsoft Windows 7, UNIX, Solaris, LINUX, Apple MAC-OS and other systems known to those skilled in the art.

CPU 1030 may be a Xenon or Core processor from Intel of America or an Opteron processor from AMID of America, or may be other processor types that would be recognized by one of ordinary skill in the art. Alternatively, the CPU 1030 may be implemented on an FPGA, ASIC, PLD or using discrete logic circuits, as one of ordinary skill in the art would recognize. Further, CPU 1030 may be implemented as multiple processors cooperatively working in parallel to perform the instructions of the inventive processes described above.

The computing device, mobile computing device, or server in FIG. 7 also includes a network controller 1006, such as an Intel Ethernet PRO network interface card from Intel Corporation of America, for interfacing with network 1040. As can be appreciated, the network 1040 can be a public network, such as the Internet, or a private network such as an LAN or WAN network, or any combination thereof and can also include PSTN or ISDN sub-networks. The network 1040 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The computing device, mobile computing device, or server further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the computing device, mobile computing device, or server, such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the computing device, mobile computing device, or server. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

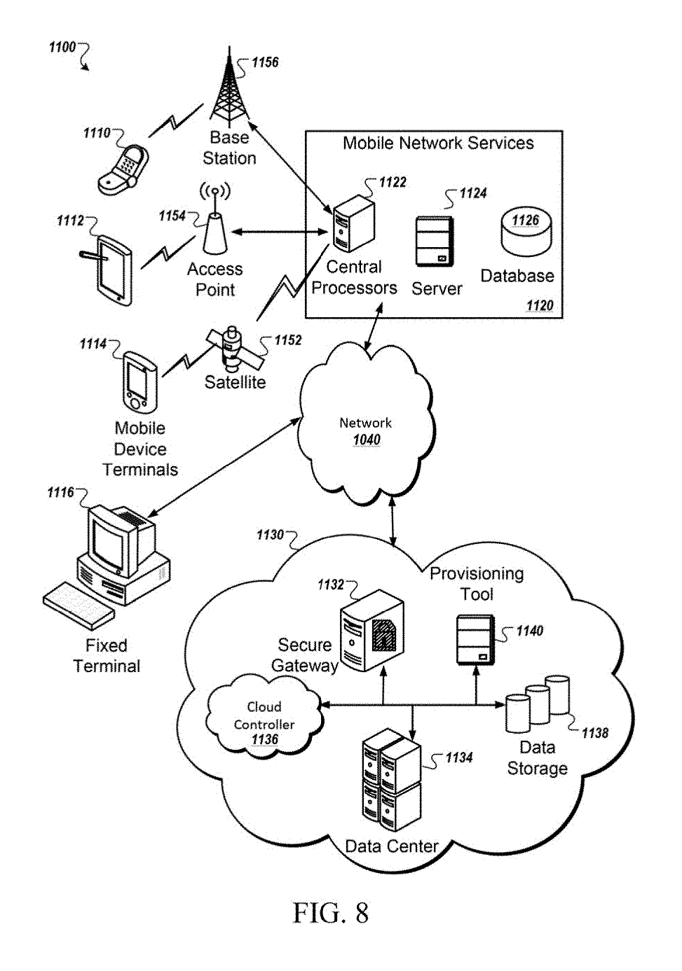

The functions and features described herein may also be executed by various distributed components of a distributed system 1100. For example, one or more processors may execute these system functions, wherein the processors are distributed across multiple components communicating in a network. The distributed components may include one or more client and server machines, which may share processing, as shown on FIG. 8, in addition to various human interface and communication devices (e.g., display monitors, smart phones, tablets, personal digital assistants (PDAs)). The network may be a private network, such as a LAN or WAN, or may be a public network, such as the Internet. Input to the distributed system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 1130, such as GOOGLE Cloud Platform™ to perform at least portions of methods or algorithms detailed above. The processes associated with the methods described herein can be executed on a computation processor, such as the GOOGLE Compute Engine by data center 1134. The data center 1134, for example, can also include an application processor, such as the GOOGLE App Engine, that can be used as the interface with the systems described herein to receive data and output corresponding information. The cloud computing environment 1130 may also include one or more databases 1138 or other data storage, such as cloud storage and a query database. In some implementations, the cloud storage database 1138, such as the GOOGLE Cloud Storage, may store processed and unprocessed data supplied by systems described herein.

The systems described herein may communicate with the cloud computing environment 1130 through a secure gateway 1132. In some implementations, the secure gateway 1132 includes a database querying interface, such as the GOOGLE BigQuery platform.

The cloud computing environment 102 may include a provisioning tool 1140 for resource management. The provisioning tool 1140 may be connected to the computing devices of a data center 1134 to facilitate the provision of computing resources of the data center 1134. The provisioning tool 1140 may receive a request for a computing resource via the secure gateway 1132 or a cloud controller 1136. The provisioning tool 1140 may facilitate a connection to a particular computing device of the data center 1134.

A network 1040 represents one or more networks, such as the Internet, connecting the cloud environment 1130 to a number of client devices such as, in some examples, a cellular telephone 1110, a tablet computer 1112, a mobile computing device 1114, and a desktop computing device 1116. The network 1040 can also communicate via wireless networks using a variety of mobile network services 1120 such as WI-FI, BLUETOOTH, cellular networks including EDGE, 3G and 4G wireless cellular systems, or any other wireless form of communication that is known. In some embodiments, the network 1102 is agnostic to local interfaces and networks associated with the client devices to allow for integration of the local interfaces and networks configured to perform the processes described herein.

The foregoing detailed description of the innovations included herein is not intended to be limited to any specific figure or described embodiment. One of ordinary skill would readily envision numerous modifications and variations of the foregoing examples, and the scope of the present disclosure is intended to encompass all such modifications and variations. Accordingly, the scope of the claims presented is properly measured by the words of the appended claims using their ordinary meanings, consistent with the descriptions and depictions herein.

1. A method for early recognition and escalating provider notification for a medical condition, the method comprising:
receiving, at a server, a patient clinical assignment and a patient health record from an electronic health records database;
setting, based on the patient clinical assignment, an escalating alert criteria including a set of diagnosis parameters and an alert timing;
determining, by processing circuitry of the server, whether a set of patient data in the patient health record corresponds to the set of diagnosis parameters of the escalating alert criteria;
determining, by the processing circuitry and when the set of patient data corresponds to the set of diagnosis parameters, a provider assignment based on the patient clinical assignment and the escalating alert criteria;
determining, by the processing circuitry, an escalating alert procedure based on at least one of the patient clinical assignment, the provider assignment, the set of patient data, and the escalating alert criteria;
outputting a notification to at least one primary communication system configured to be in communication with at least one notification device of a clinician based on the provider assignment; and
modifying, via the processing circuitry, at least one of the set of diagnosis parameters and the alert timing based on a medical order received from the at least one notification device in response to the notification.

2. The method as in claim 1, further comprising:
initiating a timer corresponding to the alert timing in response to determining that the set of patient data corresponds to the set of diagnosis parameters; and
sending, when the timer reaches a first timer threshold based on the alert timing with no medical order received, a second notification to at least one communication system configured to be in communication with at least two notification devices based on the provider assignment,
wherein at least one notification device is assigned to a clinician support.

3. The method as in claim 2, further comprising:
sending, when the timer reaches a second timer threshold based on the alert timing with no medical order received, a third notification to at least one secondary communication system configured to be in communication with at least two notification devices based on the provider assignment;
wherein the at least one secondary communication system is different than the at least one primary communication system,
wherein at least one notification device is assigned to a second clinician, and
wherein at least one notification device is assigned to a second clinician support.

4. The method as in claim 1, wherein the set of patient data includes at least one of a temperature, heart rate, respiratory rate, white blood count, systolic blood pressure with and without intravenous fluids being administered, and blood oxygen saturation with or without supplemental oxygen being administered.

5. The method as in claim 1, wherein each notification device is associated with a different level of clinical staff hierarchy.

6. The method as in claim 1, further comprising:
identifying at least one missing and/or outdated patient data from the set of patient data based on the escalating alert criteria; and
generating at least one medical order based on the identified missing and/or outdated patient data.

7. The method as in claim 1, wherein the escalating alert criteria are based on a set of patient data having different weights.

8. The method as in claim 7, wherein the weights are based on a severity of each criterion as compared to a predetermined guideline.

9. The method as in claim 7, wherein the weights are based on an ordering of the patient data received over time.

10. The method as in claim 1, wherein the medical order includes a diagnosis state and the escalating alert criteria include a silent duration configured to avoid alarm fatigue.

11. The method as in claim 1, wherein the set of diagnosis parameters include organ dysfunction criteria.

12. The method as in claim 1, wherein the set of diagnosis parameters include a set of Systemic Inflammatory Response Syndrome (SIRS) criteria and an organ dysfunction criterion.

13. The method as in claim 12, wherein the set of diagnosis parameters include at least one organ dysfunction criterion and at least two SIRS criteria.

14. The method as in claim 12, wherein the SIRS criteria are based on the set of patient data including a temperature, a heart rate, a respiratory rate, and a white blood cell count.

15. The method as in claim 12, wherein indications of organ dysfunctions include at least one of a systolic blood pressure, a blood oxygen saturation, and a lactate level.

16. A device for performing early recognition and escalating provider notification for an insidious medical condition, the device comprising:
processing circuitry configured to:
receive a patient clinical assignment from an electronic health records database,
set an escalating alert criteria based on the patient clinical assignment,
search a patient record having a set of patient data within the electronic health records database for the escalating alert criteria,
assign a provider assignment based on the patient clinical assignment and the escalating alert criteria,
create an escalating alert procedure based on at least one of the patient clinical assignment, the provider assignment, the set of patient data, and the escalating alert criteria,
send a notification to at least one primary communication system configured to be in communication with at least one notification device based on the provider assignment,
receive a medical order in response to the notification, and
modifying at least one of the set of diagnosis parameters and the alert timing based on the medical order,
wherein at least one notification device is assigned to a clinician.

17. The device of claim 16, wherein the processing circuitry is further configured to:
calculate, when the escalating alert criteria is based on a set of patient data having different weights associated for each component, a total weight,
determine when a set of patient data match the escalating alert criteria based on the total weight, and
create an escalating alert procedure based on the determination.

18. The device of claim 16, wherein each notification device is associated with a different level of clinical staff hierarchy.

19. The device of claim 16, wherein the escalating alert criteria is based on a set of patient data having different weights associated for each component.

20. A non-transitory computer-readable storage medium storing computer-readable instructions that, when executed by a computer, cause the computer to perform the method of:
receiving, at a server, a patient clinical assignment and a patient health record from an electronic health records database;
setting, based on the patient clinical assignment, an escalating alert criteria including a set of diagnosis parameters and an alert timing;
determining, by processing circuitry of the server, whether a set of patient data in the patient health record corresponds to the set of diagnosis parameters of the escalating alert criteria;
determining, by the processing circuitry and when the set of patient data corresponds to the set of diagnosis parameters, a provider assignment based on the patient clinical assignment and the escalating alert criteria;
determining, by the processing circuitry, an escalating alert procedure based on at least one of the patient clinical assignment, the provider assignment, the set of patient data, and the escalating alert criteria;
outputting a notification to at least one primary communication system configured to be in communication with at least one notification device of a clinician based on the provider assignment; and
modifying, via the processing circuitry, at least one of the set of diagnosis parameters and the alert timing based on a medical order received from the at least one notification device in response to the notification.
